(19) United States
(12) Patent Application Publication
(10) Pub. No.: US 2006/0271776 A1
(43) Pub. Date: Nov. 30, 2006

(54) Hardware dual-boot system

(76) Inventor: Gordon John Murphy, Glenview, IL (US)

Correspondence Address: GORDON J. MURPHY, 638 GARDEN COURT, GLENVIEW, IL, 60025-4105, US

(21) Appl. No.: 11/140,441

(22) Filed: May 31, 2005

(51) Int. Cl. G06F 9/00

(52) U.S. Cl. 713/2

(57) ABSTRACT

Switching apparatus is used in combination with two hard disk drives to enable one to configure one of the hard disk drives as a master and the other as a slave, without moving either hard disk drive from the computer in which it is installed and without moving any jumpers previously placed on configuration pins built into the hard disk drives. Thus, it becomes a simple matter to convert a given digital computer into the equivalent of two digital computers, each of which can be provided with its own operating system. The two operating systems may be the same or they may be different The advantages of this hardware dual-boot system over previously used software dual-boot systems include simplicity of installation, imperviousness to crashes during installation, and free access to files on either hard disk that are compatible with the operating system in use at any given time.

### BACKGROUND OF THE INVENTION

1. Field of the Invention

The present invention relates generally to the booting of a digital computer to operate under the control of an operating system selected from among multiple operating systems stored on distinct hard disk drives. The capability to boot the computer in such a way may be desirable for any of the following reasons, among others:
a) the programs to be stored in the computer may exceed the capacity of a single hard disk, and it is desired to have the operating system controlling a program resident on the same disk as that program;
b) it is desired that access to certain programs be denied to certain users of the computer; and
c) it is desired to have a distinct operating system stored on each distinct hard disk in the computer, to allow use of different operating systems at different times.

2. Description of the Prior Art

The use of dual booting in a digital computer is not new. Dual booting of digital computers has been employed to permit selection of a particular hard disk or partition from which to boot an operating system in computers in which operating systems have been installed on multiple hard disks and/or partitions. The selection of the hard disk or partition to be booted has been made heretofore by software means, however, and the process of applying software to enable dual booting has had the potential to damage or destroy files stored on the hard disk(s) installed in the computer. Moreover, there are many restrictions on file systems (e.g., FAT, NTFS, FAT32) that may be used in software-controlled dual-boot systems, as described in the topic Installing Multiple Operating Systems in the Microsoft 2000 Professional Help window. In some cases, even if the restrictions are observed, files in one file system (e.g., NTFS) are not available when an operating system based on another file system (e.g, Windows98) is in use. Under the topic Installing Multiple Operating Systems in the Microsoft 2000 Professional Help window it is stated that if one wants to install Windows NT 4.0 or Windows 2000 with Windows 95 or Windows 98, the boot volume must be formatted as FAT, not NTFS and that Windows 95 OSR2, Windows 98, and Windows 2000 will support FAT32 volumes.

It is stated also that, if one formats a Windows NT 4.0 or Windows 2000 volume with any file system other than NTFS, one will lose all NTFS-specific features, including in Windows 2000 some security features, encrypting file system (EFS) settings, disk quotas, and Remote Storage. Additionally, it is stated that Windows 95 and Windows 98 cannot recognize an NTFS partition and will identify it as unknown. The user is cautioned, therefore, that if he formats a Windows 98 partition as FAT and a Windows 2000 partition as NTFS any files on the NTFS partition will be unavailable if he tries to access them while running Windows 98.

Another disadvantage of a software-controlled dual-boot system is that each operating system is treated as a separate entity. In a software dual-boot system each operating system usually has access only to those programs and data stored on the same hard disk or partition as the operating system itself. If it is desired to be able to execute a given program or access a given data file from each of two different operating systems, the program or data file stored on the hard disk or partition containing one of the two operating systems must be replicated on the hard disk or partition containing the other operating system. This limitation also is described under the topic Installing Multiple Operating Systems in the Microsoft 2000 Professional Help window, where the user is warned that any programs and drivers he wants to use must be installed under each operating system. He is advised that, for example, if he wants to use Microsoft Word on the same computer under both Windows 98 and Windows 2000, he must start Windows 98 and install Microsoft Word and that then he must restart his computer under Windows 2000 and install Microsoft Word again.

Furthermore, establishing software-controlled dual booting is a very time-consuming and complex process, beyond the capability of many users of personal computers. Even those who are capable of establishing a software dual-boot system find the setup process tedious and unpleasant. Moreover, the software is subject to crashes and the need to repeat the setup process, possibly many times.

A purpose of this invention is to provide a system for dual booting of a computer system that is simpler to install than systems heretofore used and the installing of which does not have the potential for damaging or destroying files stored on the computer that is present in the heretofore used procedures for installing dual booting systems. A further purpose of this invention is to eliminate the restrictions on the types of file systems that may be used, so that each operating system can utilize any file system with which it is compatible, without regard to the file system requirements of another operating system to be used on the same computer. Still another purpose of this invention is to permit each operating system to execute all programs compatible with that operating system regardless of whether those programs are stored on the same hard disk as the operating system or on another hard disk. An additional purpose is to provide a dual-boot system that is impervious to software crashes in the installation process.

### BRIEF SUMMARY OF THE INVENTION

The essence of this invention is an easy-to-use apparatus for switching the status of a master mass storage unit to slave and the status of a slave mass storage unit to master. Hard disk drives are used today for mass storage, but they may be replaced in the future by flash memory or EEPROM, for example, or by other kinds of mass memory unit. Even CD-RW drives, DVD-RW drives, and DVD+RW drives may be used for mass storage units. This invention encompasses the hard disk drives used today and all successors to those drives as main mass storage units in digital systems.

Hard disk drives are manufactured with provision for configuring them for use as either a master or a slave. In some cases a distinction is made between use as a master with a slave and as a single hard disk (i.e., as a master without a slave). A drive is configured at the time the drive is installed in the computer by placing one or more small jumper connectors on designated pins in a jumper block mounted externally on the hard disk drive. Each jumper connector comprises a small plastic holder containing a metal clip that connects two connector pins on a hard disk drive. The configuration of the hard disk cannot be changed without physically accessing the disk drive and altering the placement of one or more jumper connectors on the jumper block. That is, the small jumper connectors are installed semi-permanently.

When power is applied to the computer, if jumper connectors have been installed in a proper manner on all hard disk drives in the system the computer boots from the master drive if there are two drives on the primary controller or the single drive if there is only one. Because the jumper connectors are installed semi-permanently, the computer boots from the same disk every time it is booted.

It is an object of this invention to make the changing of the jumper connections a simple matter, so that each time power is applied to the computer the computer can be booted from any desired disk. This objective is realized by eliminating the jumper connectors in favor of conductors that connect appropriate pins on the jumper blocks of the hard disk drives to a switching apparatus that can easily be actuated by the computer user, preferably from outside the computer As a result, the user can easily reconfigure each hard disk drive in the computer as a master, as a slave, or as neither, as desired, from time to time. The conductors may be permanently attached to the pins on the jumper block, or they may be removably connected by use of connectors. Furthermore, a different design of hard disk drive may be used, in which no jumper block is provided, but conductors are brought out from the interior of the drive for connection to a switching apparatus.

Additionally, some hard disk drives have a jumper position that can be used to establish “cable select” operation. When this mode of operation is selected, the master/slave status of a hard disk drive is determined by the 40-wire interface cable connected to the drive. If pin 28 on the 40-wire interface cable connected to such a hard drive is connected to ground, the hard drive serves as a master. If pin 28 on the 40-wire interface cable to the drive is not connected to ground, however, the hard drive serves as a slave. In computers that employ this mode of operation, pin 28 on one connector for a hard disk drive is permanently grounded, and pin 28 on a second connector for a hard disk drive is never grounded. The master/slave status of a given hard disk drive is then determined by its location on the cable (i.e., the connector to which it is connected). Consequently, to change the slave to master and the master to slave, it is necessary to uninstall the two hard disk drives and re-install them with the connectors interchanged This is a burdensome procedure with a potential for damaging or destroying connectors and/or sensitive electronic components.

In some embodiments of this invention, switching apparatus is provided, therefore, to enable the user of the computer to switch the connection of pin 28 on one of the 40-wire interface connectors to ground while switchably disconnecting pin 28 on the other 40-wire interface connector from ground without physically contacting either of the drives. In preferred embodiments, the switching is effected from outside the computer. Access to the switch may be limited if desired, however, by installing the switch to be actuated by the user inside the housing of the computer.

Regardless of whether the cable select mode of operation is chosen or the master/slave jumpering mode, the selection of each of the hard disk drives to be master, slave, or neither at any given time may be made by hardware (e.g., mechanical, electrical, or optical apparatus), firmware, software, or some combination thereof Typically, the switching apparatus comprises a manually operated switch. One of the hard disk drives may be a primary drive, regarded as a part of a computer itself, while the remaining hard disk drive(s) are a part of the apparatus disclosed by this invention. Alternatively, all of the hard disk drives may be a part of the apparatus disclosed by this invention.

In another form, the invention comprises the switching apparatus, but not the hard disk drives. Again, the switching apparatus is capable of establishing each hard disk drive as master, slave, or neither, provided that the hard disk drives are added.

Each hard disk drive may employ a distinct operating system, or the same operating system may be used on multiple hard disk drives.

This invention encompasses all types of hard disk drives, and all successors thereto, that can be configured as master or slave, regardless of the kind of interface with the rest of the computer, and all kinds of digital systems, special-purpose systems as well as general-purpose digital computers. The interface may be IDE, SCSI, parallel port, USB, Firewire, wireless, optical, or any other kind. The digital system may be a mainframe, a personal computer (IBM, IBM-compatible, or Macintosh, for example), or any other kind, including a reservation system and a multifunction telephone, among others, provided that the computer is capable of recognizing the hard disk drives and their master/slave status.

In other embodiments, after one hard disk drive has been established as master and a second drive has been established as slave, the roles of the two drives can be reversed by switching controlled by hardware, firmware, or software. This can be done, for example, by modifying the computer's BIOS and/or its configuration file.

If the switching system is so constructed that a change in the master/slave status of the hard disk drives can be achieved only by use of a distinct key or code for each selection, then each disk can be assigned to a different user or group of users, and each user or group of users can be provided with an operating system that is not available to the user(s) of the operating system on the other hard disk drive. The locking device in which the key or code is used may be hardware, software, firmware, or a combination thereof.

Thus, this invention discloses also a hardware dual boot system, which is more convenient to install and more convenient to operate than existing software dual boot systems. Moreover, this hardware dual boot system provides the user of an operating system on a first hard disk with access to those files on a second hard disk that are compatible with the operating system being used on the first hard disk.

Also disclosed by this invention is a switchable master/slave system comprising one hard disk drive for use with a separate hard disk drive that is a part of another digital system. The separate hard disk drive may, for example, be the original hard disk drive in a digital computer, whereas the switchable master/slave system including the separate hard disk drive is an add-on system or upgrade to the digital computer.

Yet another embodiment of this invention is switching apparatus that does not include a hard disk drive but is capable of establishing one hard disk drive as a master and a second hard disk drive as a slave, if the hard disk drives are added. Such switching appaatus may also be an add-on system or upgrade to a digital computer.

To facilitate installation of the switching apparatus disclosed in this invention in a personal computer, the switching apparatus can be provided with one or more connectors appropriate for mating with standard connectors provided within a personal computer and/or standard connectors provided on a hard disk drive. Alternatively, the switching apparatus may be hard-wired to the digital computer and/or to one or both of the hard disk drives.

A minor modification of this invention is the incorporation of the switch in the power switch of the computer so that the power switch has multiple positions: off, on with the first of two hard disk drives serving as master and the second drive serving as slave, and on with the second of the hard disk drives serving as master and the first drive serving as slave, for example.

The above and other advantages and features of the invention will be apparent to those skilled in the art from the following descriptions of particular embodiments taken in conjunction with the accompanying drawings.

### BRIEF DESCRIPTION OF THE DRAWINGS

FIG. 1 is a general block diagram of one type of master/slave switching system, comprising non-specific mass storage units.

FIG. 2 illustrates one embodiment of this invention, in which a switching circuit is used to configure one hard disk drive as a master and a second hard disk drive as a slave by short-circuiting configuration pins on the drives, with protection against inadvertent switching of the connections while power is present.

FIG. 3 depicts one form of lock that can be used to prevent unauthorized changes in short-circuit connections to the jumper pins on the hard disk drives.

FIG. 4 is an illustration of a second type of switching apparatus for use in establishing a master drive and a slave drive for use with hard disk drives configured for cable select operation.

### DETAILED DESCRIPTION OF THE INVENTION

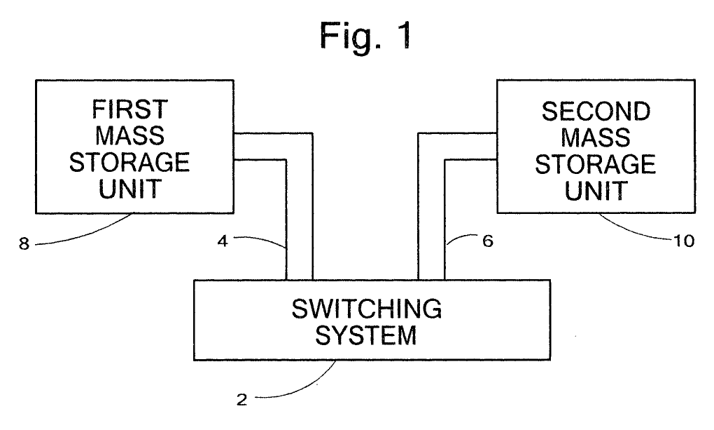

FIG. 1 is a depiction of the general considerations in some embodiments of this invention. A first mass storage unit 8 can be configured for use as a master by electrically connecting specific pins on the first mass storage unit 8 or as a slave by electrically connecting a distinct set of pins on the first mass storage unit 8. Similarly, a second mass storage unit 10 can be configured for use as a master by electrically connecting specific pins on the second mass storage unit 10 or as a slave by electrically connecting a distinct set of pins on the second mass storage unit 10. These connections, to both mass storage units, are ordinarily made by small jumper plugs that are installed semi-permanently on hard disk drives, for example, used as mass storage units.

An object of this invention is to enable one to change the connections simply and frequently, without having to uninstall the mass storage units or remove them from the computer in which they are installed. In that way, each time the computer is booted one of the two mass storage units 8 and 10 can be configured as a master and the other, as a slave, as desired. In accordance with this invention, the electrical connections are provided by a first set of one or more conductors 4 extending from the first mass storage unit 8 to a switching system 2, and by a second set of one or more conductors 6 extending from the second mass storage unit 10 to the switching system 2.

The selection of which of the two mass storage units 8 and 10 is to be the master and which is to be the slave is made by the switching system 2. The switching system 2 establishes the first mass storage unit 8 as a master and the second mass storage unit 10 as a slave by electrically connecting the master pins on the first mass storage unit 8 via the first set of conductors 4 and also electrically connecting the slave pins on the second mass storage unit 10 via the second set of conductors 6. Alternatively, the switching system 2 establishes the second mass storage unit 10 as a master and the first mass storage unit 8 as a slave by electrically connecting the master pins on the second mass storage unit 10 via the second set of conductors 6 and also electrically connecting the slave pins on the first mass storage unit 8 via the first set of conductors 4. The first set of conductors 4 and the second set of conductors 6 may be connected directly to the appropriate pins on the first mass storage unit 8 and the second mass storage unit 10, respectively, or they may be connected by use of connectors. In other embodiments, a different form of mass storage unit may be used in which the first set of conductors 4 and the second set of conductors 6 are hardwired to the electrical circuits inside the first mass storage unit 8 and the second mass storage unit 10, respectively, without the use of pins.

For some mass storage units one pin on the jumper block must be used in the selection of both a master configuration and a slave configuration. For such a mass storage unit, the connections to the switching circuit 2 must be changed in an obvious way. For some mass storage units multiple jumpers are required for a master configuration or for a slave configuration. For such a mass storage unit, also, the connections to the switching circuit 2 must be changed in an obvious way, to provide multiple short circuits instead of a single short circuit. Another obvious variation in design of the switching circuit 2 is appropriate for use with a mass storage unit for which no jumper is required for configuration as a master or for use with a mass storage unit for which no jumper is required for configuration as a slave.

For use in computers or other digital systems that allow more than two hard disk drives to operate concurrently on a common controller, a design that configures a selected one of the hard disk drives as a master and the remaining hard disk drives as slaves may be used. For such an application, the switching circuit is designed to select the hard disk drive that is to be the master and connect the jumper pins on all of the hard disk drives appropriately, as will be evident to one of ordinary skill in the art.

A simple example is based on the use of two hard disk drives, each of which has two pins that must be connected together to configure it as a master and a distinct pair of pins that must be connected together to configure it as a slave. In this example, the switching circuit 2 is a four-pole two-position switch with the first master pin and the first slave pin of the first hard disk drive A connected to a first of its rotors and a second of its rotors, respectively; and the first master pin and the first slave pin of the second hard disk drive B connected to a third of its rotors and the fourth of its rotors, respectively. The second master pin on the first hard disk drive A is connected to the normally closed contact associated with the first rotor of the switch; the second slave pin on the first hard disk drive A is connected to the normally open contact associated with the second rotor of the switch; the second master pin on the second hard disk drive B is connected to the normally open contact associated with the third rotor of the switch; and the second slave pin on the second hard disk drive B is connected to the normally closed contact associated with the fourth rotor on the switch.

Consequently, when the switch is in a first (normal) state the first master pin on the first hard disk drive A is connected to the second master pin on the first hard disk drive A and the first slave pin on the first hard disk drive A is not connected to the second slave pin on the first hard disk drive A, with the result that the first hard disk drive A is configured as a master. Also, the first master pin on the second hard disk drive B is not connected to the second master pin on the second hard disk drive B, and the first slave pin on the second hard disk drive B is connected to the second slave pin on the second hard disk drive B, with the result that the second hard disk drive B is configured as a slave.

When the switch is placed in its second state, it can be seen in a similar manner that the second hard disk drive B is configured as the master and the first hard disk drive A is configured as the slave.

In this example, each of the first set of conductors 4 and the second set of conductors 6 consists of four conductors. If other hard disk drives are used, however, the number of conductors required in each set may differ from four; and in some cases the number of conductors required in the first set 4 may differ from the number required in the second set 6.

Another example is based on a four-pole electromechanical relay with four sets of form C contacts. The armature contacts on the relay replace the rotor contacts on the four-pole two-position switch in the above example. The normally open contacts on the relay replace the normally open contacts on the four-pole two-position switch in the above example, and the normally closed contacts on the relay replace the normally closed contacts on the four-pole two-position switch in the above example. The relay coil can be connected to an appropriate source of power through a single-pole single-throw switch. When the single-pole single-throw switch is in its open state, the first hard disk drive A and the second hard disk drive B are configured as a master and a slave, respectively; and when the single-pole single-throw switch is in its closed state, the first hard disk drive A and the second hard disk drive B are configured as a slave and a master, respectively.

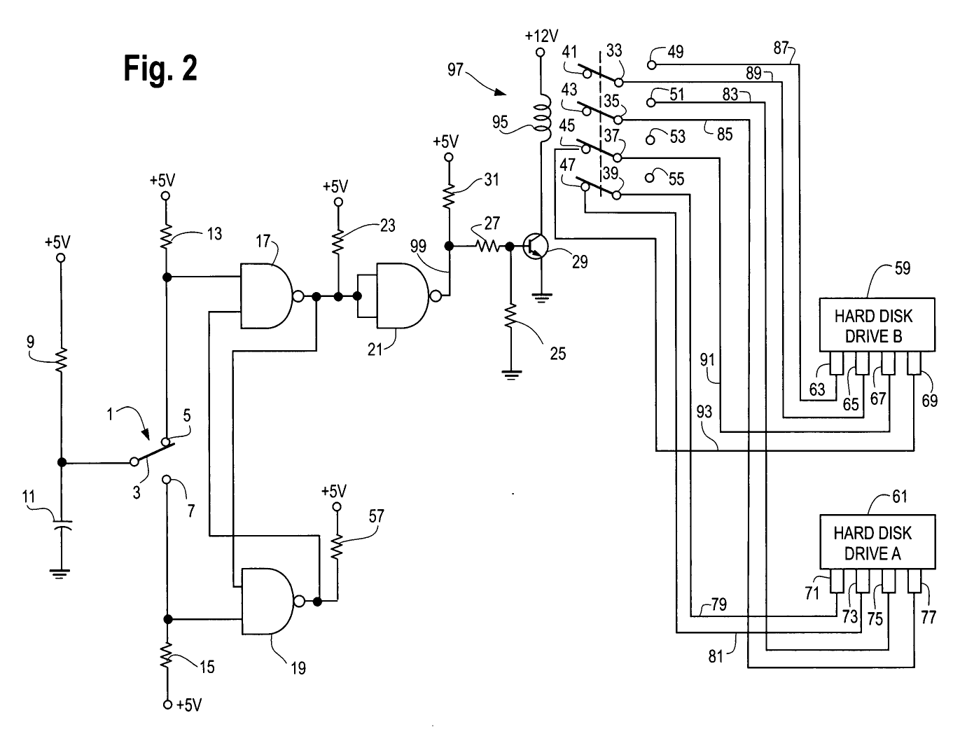

Simplicity and economy are advantages of these kinds of switching apparatus. A disadvantage is that the switch can be actuated inadvertently while the computer is in operation, with a resulting loss of data and malfunction of the software. Clearly, an improved embodiment of this invention would inhibit switching except at the time the computer is booted. Such inhibition of switching can be achieved by sampling the state of a hard disk selector switch at the instant the power is applied to the computer, establishing the corresponding state in the switching circuit, and holding that state until power is removed from the computer, even if the state of the selector switch is changed while the computer is operating. Such an embodiment of the invention is illustrated in FIG. 2.

Two hard disk drives 59 and 61 are shown in FIG. 2. These drives are not necessarily the same as the mass storage units 2 and 4 shown in FIG. 1. A single-pole, double-throw switch 1 is used to select the hard disk drive that is to be the master. The three open-collector NAND gates 17, 19, and 21 may be parts of a type 7403 integrated circuit, for example. In combination with five resistors 13, 15, 23, 31, and 57 they form a buffered flip-flop. At the instant that power is applied to the circuit, the capacitor 11 begins to charge through either a first pair of resistors 9 and 13 or a second pair of resistors 9 and 15, depending on whether the rotor 3 of the switch 1 is in contact with a first stator terminal 5 or a second stator terminal 7 of the switch 1. The charging of the capacitor 11 provides a transient logic zero at the rotor 3 of the switch 1. If at that time the rotor 3 is in contact with the second stator terminal 7 of the switch 1, then the flip-flop is forced into its logic 0 state, with a logic 0 at the output of a first primary NAND gate 17 and a logic 1 at the output of its associated buffering NAND gate 21. The logic 1 voltage at the output of the buffering NAND gate 21 is applied via a conductor 99 through a voltage divider comprising two resistors 25 and 27 to a transistor 29. As a result, the transistor 29, which may be a PN2222, for example, is turned on, producing current in the coil 95 of a relay 97 and thus actuating the relay 97. The normally closed contact pairs 33 and 41, 35 and 43, 37 and 45, and 39 and 47 of the relay 97 are then open, and the normally open contact pairs 33 and 49, 35 and 51, 37 and 53, and 39 and 55 are closed As a result, a first pair of conductors 87 and 89 forms a short circuit across the master jumper pins 63 and 65 on a first hard disk drive 59; and a second pair of conductors 83 and 85 forms a short circuit across the slave jumper pins 75 and 77 on a second hard disk drive 61. Consequently, the first hard disk drive 59 is configured as a master, and the second hard disk drive 61 is configured as a slave.

If, however, at the instant power is applied to the circuit the rotor 3 of the switch 1 is in contact with the second stator terminal 5 of the switch 1, then the flip-flop is forced into its logic 1 state, with a logic 0 at the output of the second primary NAND gate 19, a logic 1 at the output of the first primary NAND gate 17, and a logic 0 at the output of the buffering NAND gate 21. The logic 0 voltage at the output of the buffering NAND gate 21 is applied via the conductor 99 through the voltage divider comprising the two resistors 25 and 27 to the transistor 29. As a result, the transistor 29 is turned off, and the relay 97 is not energized. The relay contacts then assume their normal status, with no short circuits across the master jumper pins 63 and 65 on the first hard disk drive 59 and the slave jumper pins 75 and 77 on the second hard disk drive 61. A third pair of conductors 79 and 81 then forms a short circuit across the master jumper pins 71 and 73 on the second hard disk drive 61, and a fourth pair of conductors 91 and 93 forms a short circuit across the slave jumper pins 67 and 69 on the first hard disk drive 59. Consequently, the second hard disk drive 61 is configured as a master, and the first hard disk drive 59 is configured as a slave.

After the capacitor 11 has charged, the voltage on the rotor 3 of the switch 1, and hence the voltage on whichever of the stator terminals 5 and 7 is in contact with the rotor 3, is a logic 1 voltage. If the state of the switch 1 is changed after the capacitor 11 has charged, therefore, the buffered flip-flop does not respond, because the inputs to the first primary NAND gate 17 and the second primary NAND gate 19 are both logic 1. That is, the flip-flop memorizes the state of the switch 1 at the instant that power is applied to the circuit, and changing the state of the switch 1 thereafter has no effect on the master/slave status of either the first hard disk drive 59 or the second hard disk drive 61. Thus, changes in the master/slave status of the hard disk drives 59 and 61 are inhibited except during a short interval of time immediately after power is made available to the switching circuit.

Additional protection against switching the master/slave status of the hard disk drives 59 and 61 improperly can be provided, if desired, by ensuring that the power supply for the switching circuit maintains its output voltage longer than the power supply for the hard disk drives 59 and 61 when the system is shut down. This can be done even if the power for the switching circuit is derived from the power supply for the hard disk drives, by use of a half-wave rectifier comprising a rectifier diode and a capacitor of large capacitance to obtain the operating voltage for the switching circuit from the operating voltage for the hard disk drives, for example.

It will be evident to one of ordinary skill in the art that solid state switching can be used instead of the relay 97. That is, the switching contact pairs 33 and 41, 35 and 43, 37 and 45, 39 and 47, 33 and 49, 35 and 51, 37 and 53, and 39 and 55 on the relay 97 can be replaced with transistors and/or other solid-state elements.

Other embodiments of this invention do not include one of the hard disk drives in some cases; and neither the first hard disk drive 59 nor the second hard disk drive 61 is included in some other cases. In those embodiments, one or both hard disk drives must be obtained separately to connect to the short-circuiting conductors 79, 81, 83, 85, 87, 89, 91, and 93. In still other embodiments, different combinations of switching contacts and short-circuiting conductors are provided, to accommodate the requirements of particular hard disk drives.

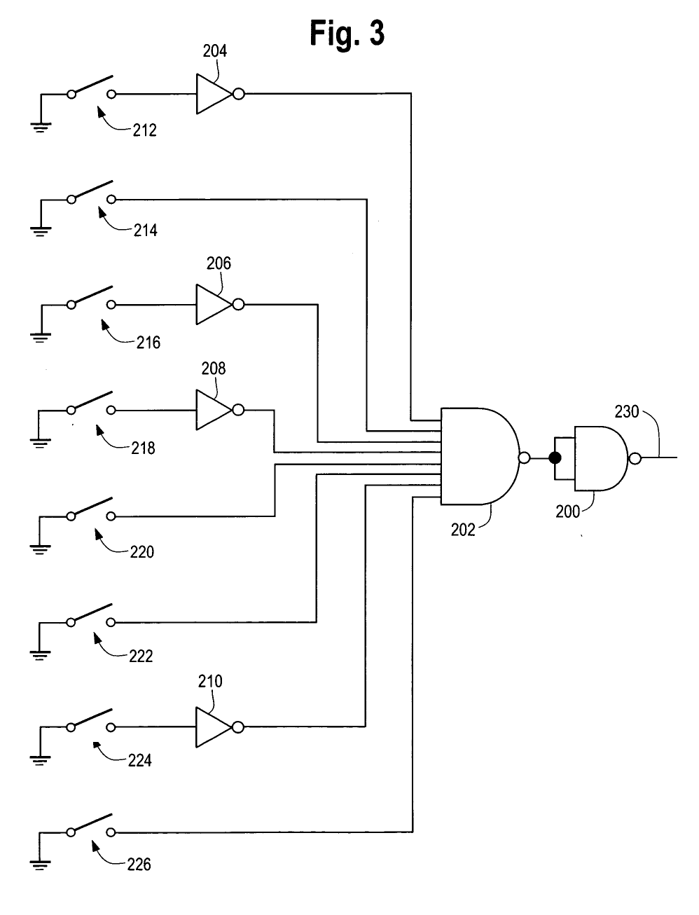

One aspect of this invention is that in some embodiments it can be used to restrict access to a particular operating system, if desired, by provision of a locking device, which may be software or hardware, electronic or mechanical or a combination of these. Such a lock can be used to prevent the enabling of one of the hard disk drives as a master even if that hard disk drive is selected by the switching circuit to be a master. One example of a lock appropriate for this purpose is shown in FIG. 3.

Single-pole, single-throw switches 212, 214, 216, 218, 220, 222, 224, and 226 are configured as an input keypad that is provided with a mechanical lock to prevent changes in the state of the keys by those who do not possess a key to the mechanical lock. If the switches are regarded as input keys in a natural binary representation, with the uppermost key 212 having the most significance and the lowermost key 226 having the least significance, then the electrical signals appearing at the inputs to the 8-input NAND gate 202 will form a natural binary code determined by the natural binary code entered via the switches 212, 214, . . . , 226. The output of the NAND gate 202, which may be a type 7430 integrated circuit, for example, is inverted by a two-input open-collector NAND gate 200 operating as an inverter. If an appropriate pull-up resistor is provided, the output voltage of the two-input open-collector NAND gate 200 is high if and only if the eight inputs to the NAND gate 202 are all high The two-input open-collector NAND gate 200 may be a part of a type 7403 quad two-input open-collector NAND gate, for example.

Because the outputs of input keys 212, 216, 218, and 224 are inverted, by inverters 204, 206, 208, and 210, respectively, the eight inputs to the 8-input NAND gate 202 will all be high if and only if the input code entered via the keypad is 01001101. Each of the inverters 204, 206, 208, and 210 may be a part of a type 7404 hex inverter, for example.

The output terminal of the two-input open-collector NAND gate 200 may be connected via a conductor 230 to the conductor 99 at the output of the buffering NAND gate 21 in FIG. 2, for example. Then the output of the buffering NAND gate 21 will be held low by the NAND gate 200 shown in FIG. 3, making the second hard disk drive 61 shown in FIG. 2 the master and the first hard disk drive 59 the slave, regardless of which of the two drives 61 and 59 is selected to be the master by the selector switch 1, unless the code entered on the keypad comprising keys 212, 214, . . . , 226 is 01001101. Thus, all users of the common digital computer except for those who know the code and have a key that provides access to the keypad for data entry can be prevented from establishing the first hard disk drive 59 as a master. Therefore, users of the computer who do not know the code or do not have a key that provides access to the keypad for data entry are able to execute those programs on both hard disks that are compatible with the operating system stored on the hard disk in the second hard disk drive 61, but none of the programs on either hard disk that run under the operating system stored on the hard disk in the first hard disk drive 59 but will not run under the operating system stored on the hard disk in the second hard disk drive 61.

Optionally, a different kind of electronic lock, similar to that used to limit access to a home, for example, may be used instead of the lock shown in FIG. 3. In some such locks, the input keys 212, 214, . . . , 226 are replaced with momentary contact keys, and a form of memory is added to retain the last code or combination entered. As a result, there is no need for a mechanical lock. Such an electronic lock can also be connected to the conductor 99 at the output of NAND gate 21 in FIG. 2, for example, to achieve the same result as the lock illustrated in FIG. 3.

If no lock is provided, open-collector gates are not required. The switching circuit can then be simplified by elimination of some components in FIG. 2, as will be evident to one of ordinary skill in the art.

In some uses of hard disk drives, neither either set of master pins nor either set of slave pins is used. Instead, jumper plugs are placed on a different set of pins on each of the two hard disk drives to configure the drives for cable select operation, and the master/slave status of each drive is determined by connecting to ground a cable select pin on the drive or not so connecting the cable select pin. On hard disk drives currently in use the cable select pin is pin 28 on the 40-pin IDE or EIDE interface connecting the hard disk drive to an IBM or IBM-compatible personal computer, for example. Typically, two connectors are provided on the interface cable. On one of the connectors, pin 28 is permanently grounded; and on the other connector, pin 28 is not grounded. If the hard disk drives are configured for cable select operation, the hard disk drive connected to the connector on which pin 28 is grounded becomes the master, and the hard disk drive connected to the connector on which pin 28 is not grounded becomes the slave. Thus, the master/slave status of each of the two hard disk drives is determined by its physical location on the interface cable.

In order to change the master drive to a slave drive and the slave drive to a master drive, the two hard disk drives must be disconnected from the interface cable and (usually) physically removed from the computer. They must then be reinstalled in new positions and reconnected to the interface cable. The process is time-consuming and inconvenient; and each time the hard disk drives are interchanged, there is a potential for damage to the connectors and damage to or even destruction of sensitive electronic components in the computer and/or the hard disk drives.

In a preferred embodiment of this invention, these problems are overcome by providing a dynamic ground connection on pin 28 of the interface bus instead of the static ground connection heretofore used. The dynamic ground connection can be supplied to the interface connectors via a switching circuit that is easily actuated by the user of the computer, preferably from outside the computer In such applications, each of the first set of conductors 4 and the second set of conductors 6 shown in FIG. 1 consists of a single conductor.

In one simple form, the switching circuit used may comprise a single-pole single-throw switch. The rotor of the switch is grounded; one stator is connected to pin 28 on the 40-wire interface connector to one hard disk drive; and the other stator is connected to pin 28 on the 40-wire interface connector to the other hard disk drive. Instead of the switch, a relay with Form C contacts that is activated by a switch may connect pin 28 on one 40-wire interface connector to ground while disconnecting pin 28 on the other 40-wire interface connector from ground. In general, the selection may be made by hardware, firmware, or software. The selection may be made by use of an independent switch, and it may be made by a modified power switch or by a modification of the computer shutdown/restart menu, for example. In particular, in accordance with this invention the usage of the ATA bus can be changed to allow software-controlled switching of the cable-select signal over the ATA bus.

Simplicity and economy are advantages of these kinds of switching apparatus. A disadvantage is that if the switch is mounted on the exterior of the computer, the switch can be actuated inadvertently while the computer is in operation, which can result in loss of data and malfunction of the software. Mounting the switch in the interior of the computer is undesirable, however, because that would result in a loss of most of the convenience of operation. Clearly, an improved embodiment would inhibit switching except at the time the computer is booted.

One embodiment of this invention incorporates a switching circuit that provides such inhibition of switching by use of a power-on reset kind of circuit (comprising a resistor-capacitor charging circuit or a 555 timer circuit, for example), a single-pole, single-throw switch, and a relay with a holding contact. When the computer is booted, the +12 volt supply is connected for only a short interval of time (the power-on delay time) to the rotor of the single-pole, single-throw switch. The stator terminal of the switch is connected to one terminal of the relay coil; the other terminal of the relay coil is grounded. The relay has two sets of double-throw contacts (i.e., form C). The contacts in one of the two sets of contacts are connected as the contacts on the single-pole, double-throw switch in the earlier example. The second set of contacts on the relay is used as part of a holding circuit.

If the switch was open, and hence the first of the two hard disk drives was selected as master with the second drive as slave, at the time the computer was booted, the relay is not actuated at boot-up; and it cannot be actuated after the power-on delay time has expired because the voltage applied to the rotor of the single-pole, single-throw switch is then zero. Therefore, the determination of the master/slave status of each hard disk drive cannot be changed in that event after the computer boots up.

If the switch was closed, and hence the second of the two hard disk drives was selected as master with the first drive as slave, at the time the computer was booted, the relay is actuated at boot-up. The holding contacts then serve to maintain the connection from the +12V supply to the relay coil after the power-on delay time has expired. Because of the action of the holding circuit, the determination of the master/slave status of each hard disk drive cannot be changed later by changing the state of the switch in that event, either.

Thus, changes in the master/slave status of each of the mass storage units are inhibited except at the time the computer is booted.

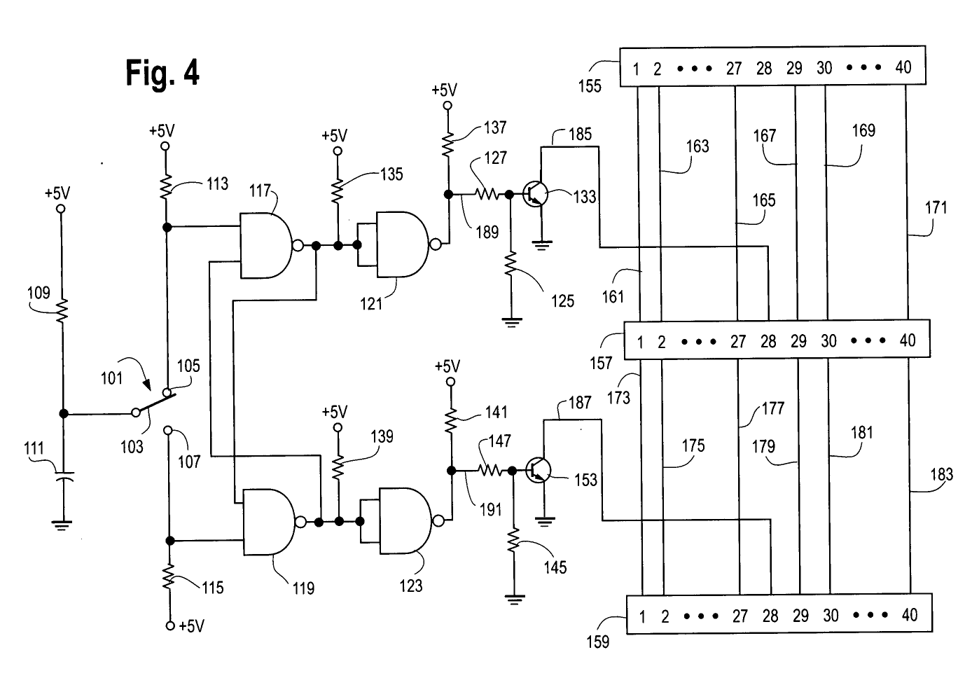

In another, preferred, embodiment the relay of the preceding example is replaced by a solid-state circuit. Such an embodiment is illustrated in the following example, with reference to FIG. 4.

A first 40-pin connector 155 is used to connect the apparatus shown in FIG. 4 to a computer (e.g., to an ATA bus in an IBM or IBM-compatible personal computer) via an IDE cable or an EIDE cable, for example. Pins 1 through 27 and 29 through 40 of the first 40-pin connector 155 are connected to pins 1 through 27 and 29 through 40, respectively, of a second 40-pin connector 157 and to pins 1 through 27 and 29 through 40, respectively, of a third 40-pin connector 159.

The 40-pin connector on a hard disk drive may be connected to the second 40-pin connector 157, and the 40-pin connector on a second hard disk drive may be connected to the third 40-pin connector.

A single-pole, double-throw switch 101 is used instead of a single-pole, single-throw switch as in the relay-based embodiment described earlier, because the buffered flip-flop comprising open-collector NAND gates 117, 119, 121, and 123 and the associated pull-up resistors 113, 115, 135, 137, 139, and 141 has no default state, as does the relay in the relay-based embodiment. The four open-collector NAND gates 117, 119, 121, and 123 may collectively be a type 7403 integrated circuit, for example. At the instant that power is applied to the circuit, the capacitor 111 begins to charge through the resistor 109 in parallel with either the pull-up resistor 113 at the input to the first NAND gate 117 or the pull-up resistor 115 at the input to the second NAND gate 119, depending on the state of the switch 101, providing a transient logic zero at the rotor 103 of the switch 101.

If at that time the rotor 103 is in contact with a first stator terminal 107 of the switch 101, then the flip-flop is forced into its logic 0 state, with a logic 0 at the output of the first NAND gate 117 and a logic 1 at the output of its associated buffering NAND gate 121. The logic 1 voltage at the output of the buffering NAND gate 121 is applied via a conductor 189 through a first voltage divider comprising two resistors 125 and 127 to a first transistor 133. As a result, the first transistor 133 (which may be a PN2222, for example) is turned on, short-circuiting pin 28 on the second 40-pin connector 157 to ground via a conductor 185. Accordingly, a hard disk drive configured for cable select operation and connected to the second 40-pin connector 157 will be recognized by the computer as a master.

At the same time, the buffered flip-flop provides a logic 1 at the output of the second primary NAND gate 119 and a logic 0 at the output of its associated buffering NAND gate 123. The logic 0 voltage is applied via a conductor 191 through a second voltage divider comprising two resistors 145 and 147 to a second transistor 153 (which may be a PN2222 also, for example). Consequently, the second transistor 153 is prevented from conducting collector current. Pin 28 on the third 40-pin connector 159 is, therefore, not short-circuited to ground. Accordingly, a hard disk drive configured for cable select operation and connected to the third 40-pin connector 159 will be recognized by the computer as a slave.

If, however, at the instant power is applied to the circuit the rotor 103 of the switch 101 is in contact with the second stator terminal 105 of the switch 101, then the flip-flop is forced into its logic 1 state, with a logic 0 at the output of the second primary NAND gate 119 and a logic 1 at the output of the buffering NAND gate 123. The logic 1 voltage at the output of the buffering NAND gate 123 is applied via a conductor 191 through the second voltage divider, comprising two resistors 145 and 147, to the second transistor 153. As a result, the second transistor 153 is turned on, short-circuiting pin 28 on the third 40-pin connector 159 to ground via a conductor 187. Accordingly, a hard disk drive configured for cable select operation and connected to the third 40-pin connector 159 will be recognized by the computer as a master.

At the same time, the buffered flip-flop provides a logic 1 at the output of the first primary NAND gate 117 and a logic 0 at the output of its associated buffering NAND gate 121. Consequently, the first transistor 133 is turned off, disconnecting pin 28 on the second 40-pin connector 157 from ground. Accordingly, a hard disk drive configured for cable select operation and connected to the second 40-pin connector 157 will be recognized by the computer as a slave.

After the capacitor 111 has charged, the voltage on the rotor 103 of the switch 101, and hence the voltage on whichever of the stator terminals 105 and 107 is in contact with the rotor 103, is a logic 1 voltage. If the state of the switch 101 is changed after the capacitor 111 has charged, therefore, the buffered flip-flop does not respond, because the inputs to each of the first primary NAND gate 117 and the second primary NAND gate 119 are both logic 1. That is, the flip-flop memorizes the state of the switch 101 at the instant that power is applied to the circuit, and changing the position of the switch 101 thereafter has no effect on the master/slave status of the two hard disk drives. Thus, changes in the master/slave status of the two hard disk drives are inhibited except during a short interval of time immediately after power is made available.

The cable comprising conductors 161, 163 . . . 165, 167, and 169 . . . 171 maybe connected to the computer directly by use of the first 40-pin connector 155 shown, by use of that connector and an additional cable assembly, or even by hardwire connection. The same cable, together with an additional conductor 185, is shown connected to the second 40-pin connector 157 in FIG. 4, and an extension of the same cable comprising conductors 173, 175 . . . 177, 179, and 181 . . . 183, together with an additional conductor 187, is shown connected to the third 40-pin connector 159. The 40-wire cable connected to the second 40-pin connector 157 forms an interface bus for a hard disk drive that may be connected to that 40-pin connector 157. Similarly, the 40-wire cable connected to the third 40-pin connector 159 forms an interface bus for a hard disk drive that may be connected to that 40-pin connector 159.

The second 40-pin connector 157 may be connected to a mating 40-pin connector on a hard disk drive directly or by use of one or more intermediate cable assemblies. Alternatively, a hardwired connection to the electric circuit inside a hard disk drive may be used, however.

Similarly, the third 40-pin connector 159 may be connected to a mating 40-pin connector directly or by use of one or more intermediate cable assemblies. Alternatively, a hardwired connection to the electric circuit inside a hard disk drive may be used, however.

Although the above description of a preferred embodiment of this invention encompasses the two hard disk drives, in other embodiments a switching system exemplified by FIG. 4 can be provided alone, with hard disk drives to be obtained from another source. In still other embodiments, a switching system exemplified by FIG. 4 can be provided together with a single hard disk drive, with a second hard disk drive to be obtained from another source.

In each case, use of a particular one of the two hard disk drives as a master can be inhibited by use of a lock, such as the one shown in FIG. 3, for example. Such a lock can be used to prevent the enabling of a hard disk drive as a master even if that hard disk drive is selected by the switching circuit to be a master. If the output conductor 230 of the two-input NAND gate 200 in FIG. 3 is connected only to the output conductor 189 of the first buffer NAND gate 121 shown in FIG. 4, then the first transistor 133 shown in FIG. 4 cannot be turned on unless the correct combination is entered into the lock. If the first transistor 133 in FIG. 4 cannot be turned on, the hard disk drive connected to the second 40-pin connector 157 in FIG. 4 will not be recognized by the computer as a master regardless of the state of the switch 101 at the instant the computer is turned on. Under those circumstances, consequently, the computer can be operated only with the hard disk drive connected to the third 40-pin connector 159 as the master and the hard disk drive connected to the second 40-pin connector 157 as the slave.

Similarly, if the output conductor 230 of the two-input NAND gate 200 shown in FIG. 3 is connected only to the output conductor 191 of the second buffer NAND gate 123 shown in FIG. 4, then the second transistor 153 shown in FIG. 4 cannot be turned on unless the correct combination is entered into the lock If the second transistor 153 in FIG. 4 cannot be turned on, the hard disk drive connected to the third 40-pin connector 159 shown in FIG. 4 will not be recognized by the computer as a master regardless of the state of the switch 101 at the instant the computer is turned on. Under those circumstances, consequently, the computer can be operated only with the hard disk drive connected to the second 40-pin connector 157 as the master and the hard disk drive connected to the third 40-pin connector 159 as the slave.

Finally, if the output conductor 230 of the two-input NAND gate 200 shown in FIG. 3 is connected to the output conductor 189 of the first buffer NAND gate 121 shown in FIG. 4 through a first switching diode and to the output conductor 191 of the second buffer NAND gate 123 through a second switching diode in such a way that the two switching diodes will conduct when the output of the two-input NAND gate 200 is a logic 0, then neither the first transistor 133 nor the second transistor 153 shown in FIG. 4 can be turned on unless the correct combination is entered into the lock. If neither the first transistor 133 nor the second transistor 153 can be turned on, neither the hard disk drive connected to the second 40-pin connector 157 nor the hard disk drive connected to the third 40-pin connector 159 shown in FIG. 4 will be recognized by the computer as a master regardless of the state of the switch 101 at the instant the computer is turned on. In that case, therefore, the computer cannot be operated at all unless the correct combination is entered into the lock. Then, when the correct combination is entered into the lock, the master drive and the slave drive are the drives so selected by the state of the switch 101 at the instant the computer is turned on.

As in the earlier example, other kinds of lock suitable for use with the system illustrated in FIG. 4 will be known to one of ordinary skill in the art.

Although the invention disclosed herein has been described with reference to specific embodiments, various modifications and improvements will occur to those skilled in the art. The essence of the invention is the use of a switching circuit that provides for dynamic changes in the master/slave status of hard disk drives. The determination of whether a given hard disk drive is to be a master or a slave at any given time may be made by hardware or by firmware or software. Not every embodiment necessarily comprises the hard disk drives themselves. In some embodiments, neither hard disk drive is included. In some other embodiments, one of the hard disk drives is a primary hard disk drive, regarded as a part of a computer itself, while another hard disk drive is a part of the apparatus disclosed by this invention. In still other embodiments, both the master and the slave hard disk drives are parts of the apparatus disclosed by this invention.

Although specific examples have been given with reference to IBM or IBM-compatible personal computers, other computers may be used as well, in particular computers with a plug and play capability. In some embodiments the computer must be capable of recognizing a hard disk drive connected to it and recognizing whether the hard disk drive is configured for use as a master with or without a slave or as a slave. In other embodiments, wherein the hard disk drives are configured for cable select operation, the computer need not be able to recognize whether a drive has been configured as master or slave.

Variations in design without departing from the spirit and scope of this invention are encompassed by the claims appended below. It is to be understood, therefore, that this invention is not limited to the particular forms illustrated, nor to particular devices known at present, but includes all arrangements of apparatus that do not depart from the spirit and scope of the appended claims and specific devices now known or to be developed in the future.

What I claim as my invention is:

1. Apparatus for determining which of two mass storage units is to be the master and which is to be the slave, comprising a switching circuit that performs the functions of:
(a) providing short circuits across those terminals, if any, of a first mass storage unit that must be connected together for it to be configured as a master;
(b) ensuring that there is no short circuit across those terminals of said first mass storage unit that must not be connected together if it is to be configured as a master;
(c) providing short circuits across those terminals, if any, of a second mass storage unit that must be connected together for it to be configured as a slave; and
(d) ensuring that there is no short circuit across those terminals of said second mass storage unit that must not be connected together if it is to be configured as a slave.

2. Apparatus for determining which of two mass storage units is to be the master and which is to be the slave as claimed in claim 1, further comprising locking apparatus for preventing the enabling of one of said two mass storage units as a master.

3. Apparatus for determining which of two mass storage units is to be the master and which is to be the slave as claimed in claim 1, further comprising apparatus to inhibit a change in the master/slave status of said first mass storage unit and said second mass storage unit except during a short interval of time immediately following the time at which power is made available.

4. Apparatus for determining which of two mass storage units is to be the master and which is to be the slave as claimed in claim 1, further comprising a manually operable switch for selecting which of said mass storage units is to be the master and which is to be the slave.

5. Apparatus for determining which of two mass storage units is to be the master and which is to be the slave as claimed in claim 1, further comprising at least one of said two mass storage units.

6. Apparatus for determining which of two mass storage units is to be the master and which is to be the slave as claimed in claim 1, further comprising:
(a) locking apparatus for preventing the enabling of one of said two mass storage units as a master, and
(b) apparatus to inhibit a change in the master/slave status of said first mass storage unit and said second mass storage unit except during a short interval of time immediately following the time at which power is made available.

7. Apparatus for determining which of two mass storage units is to be the master and which is to be the slave as claimed in claim 1, further comprising:
(a) apparatus to inhibit a change in the master/slave status of said first mass storage unit and said second mass storage unit except during a short interval of time immediately following the time at which power is made available; and
(b) at least one of said two mass storage units.

8. Apparatus for determining which of two mass storage units is to be the master and which is to be the slave as claimed in claim 1, further comprising:
(a) locking apparatus for preventing the enabling of one of said two mass storage units as a master;
(b) a manually operable switch for selecting which of said mass storage units is to be the master and which is to be the slave;
(c) apparatus to inhibit a change in the master/slave status of said first mass storage unit and said second mass storage unit except during a short interval of time immediately following the time at which power is made available; and
(d) at least one of said two mass storage units.

9. Apparatus for determining which of two mass storage units configured for cable select operation is to be the master and which is to be the slave, comprising a switching circuit that performs the functions of:
(a) connecting to ground the cable select pin on an interface for the master; and
(b) disconnecting from ground the cable select pin on an interface for the slave.

10. Apparatus for determining which of two mass storage units configured for cable select operation is to be the master and which is to be the slave as claimed in claim 9 wherein said switching circuit includes a manually operable switch.

11. Apparatus for determining which of two mass storage units configured for cable select operation is to be the master and which is to be the slave as claimed in claim 9 wherein said switching circuit comprises apparatus to inhibit a change in the master/slave status of said first mass storage unit and said second mass storage unit except during a short interval of time immediately following the time at which power is made available.

12. Apparatus for determining which of two mass storage units configured for cable select operation is to be the master and which is to be the slave as claimed in claim 9 further comprising at least one of said two mass storage units.

13. Apparatus for determining which of two mass storage units configured for cable select operation is to be the master and which is to be the slave as claimed in claim 9 wherein
(a) said switching circuit comprises apparatus to inhibit a change in the master/slave status of said first mass storage unit and said second mass storage unit except during a short interval of time immediately following the time at which power is made available; and
(b) locking apparatus is provided for preventing the enabling of one of said two mass storage units as a master.

14. Apparatus for determining which of two mass storage units configured for cable select operation is to be the master and which is to be the slave as claimed in claim 9 further comprising:
(a) apparatus to inhibit a change in the master/slave status of said first mass storage unit and said second mass storage unit except during a short interval of time immediately following the time at which power is made available; and
(b) at least one of said two mass storage units.

15. Apparatus for determining which of two mass storage units configured for cable select operation is to be the master and which is to be the slave as claimed in claim 9 wherein:
(a) locking apparatus for preventing the enabling of one of said two mass storage units as a master is included;
(b) said switching circuit comprises a manually operable switch;
(c) said switching circuit comprises apparatus to inhibit a change in the master/slave status of said first mass storage unit and said second mass storage unit except during a short interval of time immediately following the time at which power is made available; and
(d) at least one of said mass storage units is included.

16. A hardware dual boot system comprising a switching circuit for connecting a selectable one of two mass storage units as a master and the second of said two mass storage units as a slave.

17. A hardware dual boot system as claimed in claim 16 further comprising apparatus to inhibit a change in the master/slave status of said first mass storage unit and said second mass storage unit except during a short interval of time immediately following the time at which power is made available.

18. A hardware dual boot system as claimed in claim 16 further comprising:
(a) apparatus to inhibit a change in the master/slave status of said first mass storage unit and said second mass storage unit except during a short interval of time immediately following the time at which power is made available; and
(b) at least one of said two mass storage units.

19. Apparatus for determining which of two mass storage units configured for cable select operation is to be the master and which is to be the slave as claimed in claim 16 wherein said switching circuit comprises a manually operable switch.

20. Apparatus for determining which of two mass storage units is to be the master and which is to be the slave as claimed in claim 16, further comprising:
(a) apparatus to inhibit a change in the master/slave status of said first mass storage unit and said second mass storage unit except during a short interval of time immediately following the time at which power is made available;
(b) locking apparatus for preventing the enabling of one of said two mass storage units as a master; and
(c) at least one of said two mass storage units.
